(19) United States
(12) Patent Application Publication
(10) Pub. No.: US 2013/0215279 A1
(43) Pub. Date: Aug. 22, 2013

(54) System and Method for Creating and Displaying Points of Interest in Video Test Results

(71) Applicants: Alejandro Rivas-Micoud, Tiburon, CA (US); Ariel Rivas-Micoud, Madrid (ES); Francisco Erlich, Madrid (ES); Luis Gonzalez, Madrid (ES)

(72) Inventors: Alejandro Rivas-Micoud, Tiburon, CA (US); Ariel Rivas-Micoud, Madrid (ES); Francisco Erlich, Madrid (ES); Luis Gonzalez, Madrid (ES)

(21) Appl. No.: 13/399,853

(22) Filed: Feb. 17, 2012

(51) Int. Cl. H04N 17/00

(52) U.S. Cl. 348/180; 348/E17.001

(57) ABSTRACT

A method for creating and displaying points of interest in video test results comprises obtaining a plurality of video test results, each of the plurality of video test results corresponding to a tester, and for each of the plurality of video test results, displaying the video test results, receiving at least one indicator of a point of interest in the video test results, receiving a text comment associated with the point of interest, and saving a timestamp that indicates a position in the video test results of the point of interest and a text comment in a memory. Then a graphical user interface is created that displays the timestamp and text comment of each point of interest in the plurality of test video results, where selection of a point of interest causes the corresponding video test result to be displayed beginning at the timestamp of the selected point of interest.

### FIELD OF THE INVENTION

The invention relates to online video test recording and playback, and more particularly to a system and method for creating and displaying points of interest in online video test results.

### BACKGROUND

Companies conducting marketing and advertising campaigns, market research, or user interface development may wish to study the reactions and interactions of persons in their homes or offices with offline and online content such as websites, advertisements, video or other types of media, prototypes, messaging, and the like. For example, companies may want to test consumers' reactions to advertisements or promotions before formally launching them. Others may want to conduct usability tests of new software or games. Such studies enable companies to develop products that are more suited to their target segments, conduct user experience and usability studies on prototypes and user interfaces, optimize advertisement and media planning, diagnose analytics results, conduct comparisons for branding initiatives, and many other activities that rely on user feedback.

A typical method of conducting such studies is to assign testers to interact with a website or other material, whether offline or online assets, and to record their interactions along with the testers' reactions. A tester may use a computer at a testing location local to the test administrator or a computer at a location remote from the test administrator. Such testing typically includes capturing video of the tester's screen during a test. In one example, the video of the tester's screen shows the positions of the cursor/pointer on the screen as the tester navigates a webpage, user interface, or other material, as well as all other actions that take place on the screen such as videos, changes of displays, applications reacting to tester input, including the sound if any transmitted from the screen device, etc. Such testing also typically includes capturing video and/or audio of the tester. The audio captures comments and opinions of the tester (“thinking aloud”), and the video captures facial expressions, posture, and other non-verbal indications of the tester's reaction to the material being tested.

The test results include the captured video of the tester's screen during the test, not just the browsers, but the entire desktop screen, the audio generated by any part of the device, the audio and video of the tester (typically captured by a web cam), and may additionally include the tester's answers to specific questions posed after a task has been completed. An analysis of the test results typically involves playing back the video and audio of the tester's device and the video and audio of the tester. Each tester's test results may have a duration of several minutes, for example about ten minutes, or may be significantly longer. Because a test is typically performed by several testers, the total time to view the test results of all testers can be significant. Thus there is a need for a way to identify and playback on demand the most important or interesting portions of all of the test results for a particular test.

### SUMMARY

A method for creating, annotating, and displaying hyperlinked points of interest in video test results comprises obtaining a plurality of video test results, each of the plurality of video test results corresponding to a tester. Each of the plurality of video test results typically includes a video of the tester and a video of the tester's screen during the test. For each of the plurality of video test results, the method further includes displaying the video test results, receiving at least one indicator of a point of interest in the video test results, receiving a text comment associated with the point of interest, and saving a timestamp that indicates a position in the video test results of the point of interest and a text comment in a memory. Then a graphical user interface is created that displays the timestamp and text comment of each point of interest in the plurality of test video results, where selection of a point of interest causes the corresponding video test result to be displayed beginning at the timestamp of the selected point of interest. The graphical user interface is configured to enable the points of interest and associated text comments to be edited or deleted, or for additional points of interest to be created.

### BRIEF DESCRIPTION OF THE DRAWINGS

FIG. 1 is a diagram of one embodiment of a system for creating and displaying points of interest in test results, according to the invention;

FIG. 2 is a diagram of one embodiment of the test administrator of FIG. 1, according to the invention;

FIG. 3 is a diagram of one embodiment of the test results of FIG. 2, according to the invention;

FIG. 4 is a diagram of one embodiment of the tester data of FIG. 3, according to the invention;

FIG. 5 is a flowchart of method steps for creating points of interest for a test, according to one embodiment of the invention;

FIG. 6 is a diagram of one embodiment of a user interface for creating points of interest of a test, according to the invention;

FIG. 7 is a diagram of one embodiment of a user interface for viewing points of interest of a test, according to the invention; and

FIG. 8 is a diagram of one embodiment of a user interface for viewing playback of video test results with points of interest, according to the invention.

### DETAILED DESCRIPTION

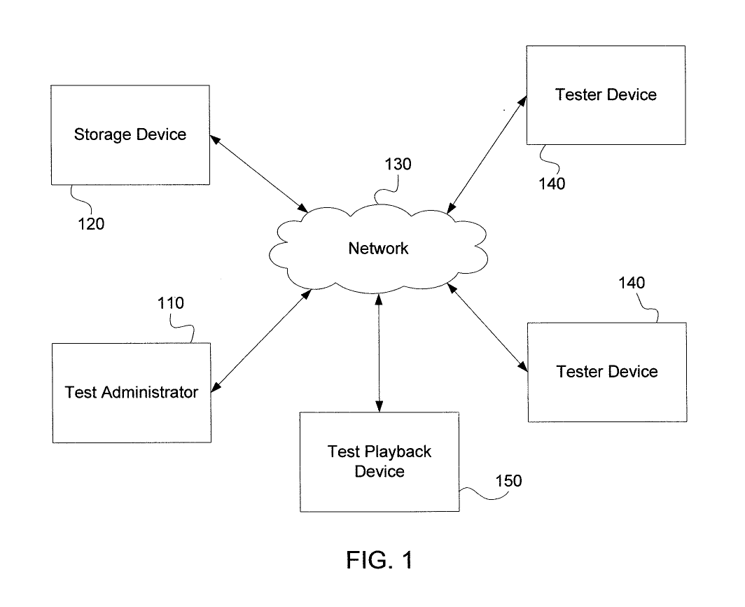

FIG. 1 is a diagram of one embodiment of a system for creating and displaying points of interest in test results, according to the invention. A test administrator 110 is coupled to a network 130. A plurality of tester devices 140 are coupled to network 130 and are capable of communicating with test administrator 110. A storage device 120 is coupled to network 130 and is capable of communicating with test administrator 110. A test playback device 150 is coupled to network 130 and is capable of communicating with test administrator 110 and optionally storage device 120. Network 130 may be a wide area network, a local area network, or a combination, and may include both wired and wireless communication links. In one embodiment, storage device 120 is co-located with test administrator 110 and in other embodiments storage device 120 is located remotely from test administrator 110. In one embodiment, one or more of the plurality of tester devices 140 may be co-located with test administrator 110.

Test administrator 110 administers tests performed by testers using tester devices 140. Tester device 140 may be a desktop or laptop computer, a netbook computer, a tablet computer, a smartphone, or any other type of computing device that includes a display screen. The tests may be tests of websites, webpages, software applications, advertisements, promotions, movie trailers, television pilots, or any other material that a tester is able to interact with or react to via a computing device having a display screen. In one embodiment, test administrator 110 sends a testing software application to each tester device 140, which is then installed on tester device 140. In one embodiment, the testing software application is configured as a plug-in to a web browser application. The testing software application is configured to capture video of the tester device's 140 screen and any audio generated by the tester's device 140 during the test and also to control the capture of video and audio of the tester during the test. The video and audio of test device 140 may be in separate files or may be combined in a single audiovisual file. Similarly, the video and audio of the tester may be in separate files or may be combined in a single audiovisual file. The video and audio of the tester may be captured using a camera and microphone built into the tester device 140 or using a camera and microphone coupled to the tester device 140. The testing software application is also configured to send the captured screenshot video and the audio and video of the tester to test administrator 110.

Test playback device 150 may be a desktop or laptop computer, a tablet computer, a smartphone, or any other type of computing device that includes a display screen. A user of test playback device 150 is able to access the results of the tests, which include the screen video and the audio and video of the tester captured during each test. An agent of test administrator 110 is enabled to review the test results and to create points of interest via test playback device 150, as further described below. Although only one test playback device 150 is shown in FIG. 1, any number of test playback devices 150 are within the scope of the invention.

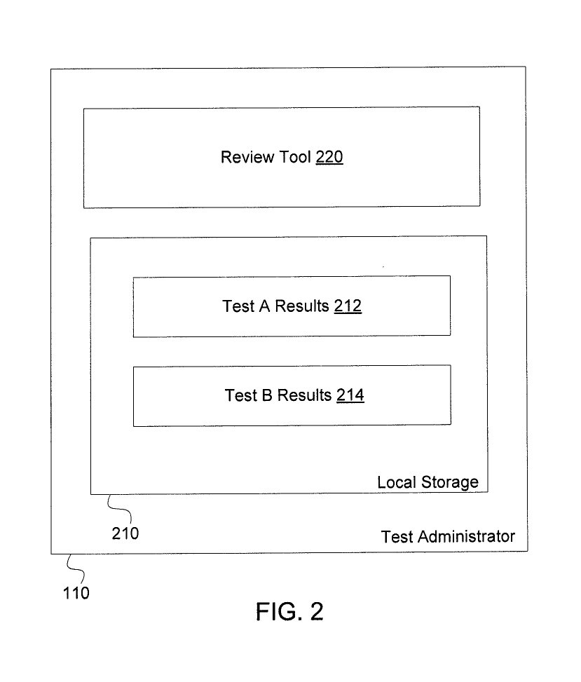

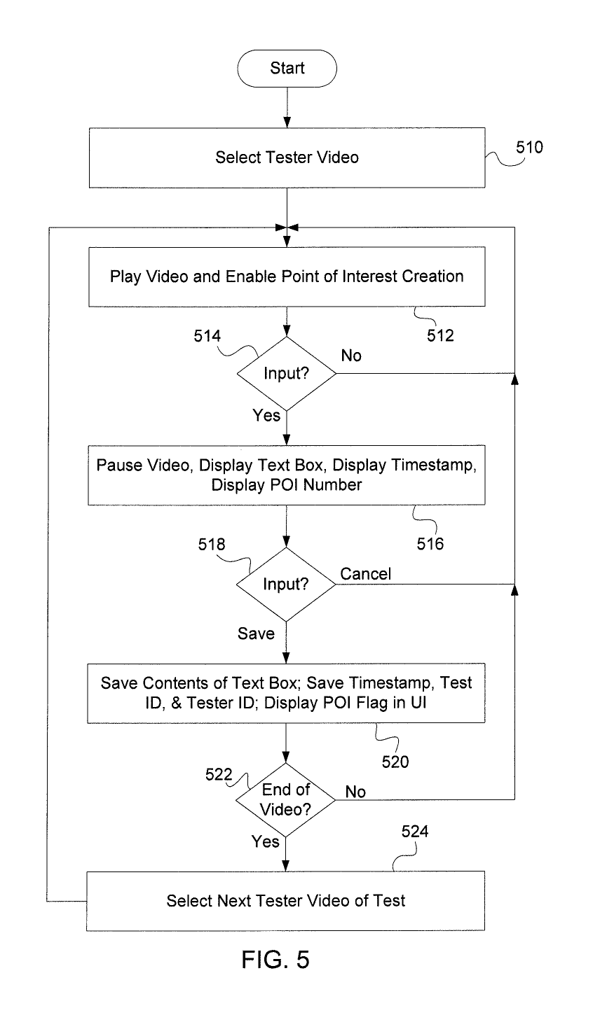

FIG. 2 is a diagram of one embodiment of the test administrator of FIG. 1, according to the invention. Test administrator 110 includes, but is not limited to, a local storage 210 and a review tool 220. Local storage 210 includes, but is not limited to, test A results 212 and test B results 214. Test A results 212 includes all the results received from testers that have performed a test A, and test B results 214 includes all the results received from testers that have performed a test B. Although the results of only two tests are shown in FIG. 2, any number of test results is within the scope of the invention. Review tool 220 enables an agent or agents of the entity administering the tests to review the test results and create points of interest for each test. Creating points of interest is further discussed below in conjunction with FIG. 5. In one embodiment review tool 220 is a PHP script that interacts with a client program, such as an Adobe® Flex client, that is sent to test playback device 150.

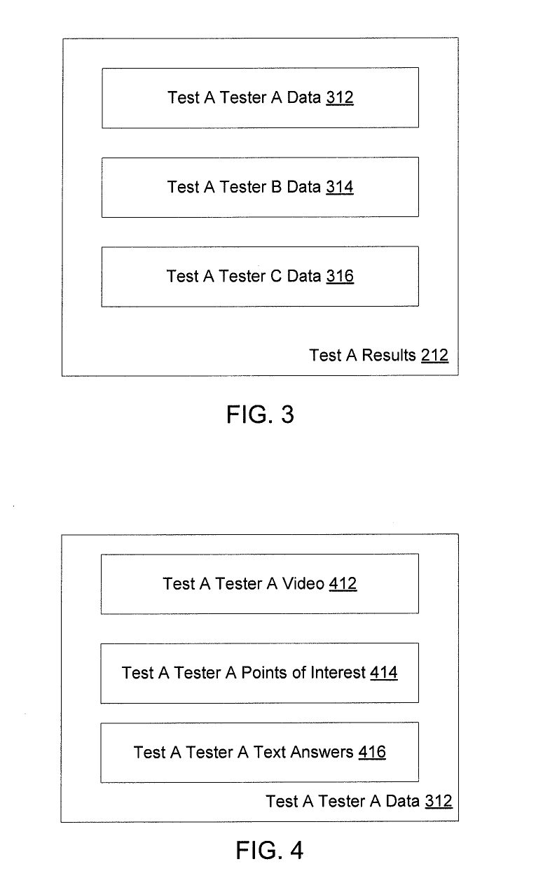

FIG. 3 is a diagram of one embodiment of the test results of FIG. 2, according to the invention. Test A results 212 includes, but is not limited to, test A tester A data 312, test A tester B data 314, and test A tester C data 316. In the FIG. 3 embodiment, test A results 212 includes results from three testers that have performed test A. Although results of three testers are shown in FIG. 3, any number of testers for a particular test is within the scope of the invention.

FIG. 4 is a diagram of one embodiment of the tester data of FIG. 3, according to the invention. Test A tester A data 312 includes, but is not limited to, test A tester A video 412, test A tester A points of interest 414, and test A tester A text answers 416. In one embodiment, test A tester A video 412 includes a screenshot video of tester A's display screen and any audio generated by tester A's device during the test, an audio file of tester A's verbal statements during the test, and a camera video of tester A during the test. In another embodiment, the camera video and audio of tester A during the test may be combined in a single audiovisual file. Test A tester A points of interest 414 include points of interest created by an agent of the entity administering test A. Each point of interest includes a test identifier, a tester identifier, a timestamp, and a text comment. The timestamp identifies a specific time in the test A tester A video 412 at which the significant or interesting portion of the test A tester A video 412, as determined by the agent, begins. Test A tester A text answers 416 includes the text of answers provided by tester A to written questions posed after completion of test A.

FIG. 5 is a flowchart of method steps for creating points of interest for a test, according to one embodiment of the invention. In step 510, review tool 220 selects a tester video for playback from the test results of a particular test, for example test A results 212. In step 512, review tool 220 plays the video and enables an agent viewing the video to create points of interest. In one embodiment, review tool 220 plays the video by providing a client program, such as an Adobe® Flex client, and the video to test playback device 150 for display by a web browser program. The client program also causes the web browser to display a user interface that enables the agent to create points of interest. In step 514, review tool 220 determines whether the agent has entered input that indicates that a point of interest should be created. If no input from the agent is received, the method continues with step 512. If such input from the agent is received, then in step 516 review tool 220 causes the client program to pause the video, display a text box for insertion of comment text, display a timestamp representing the elapsed time of the video, and display a point of interest number.

In step 518, review tool 220 determines whether the agent has indicated that the point of interest should be saved or canceled. If the input received from the client program interface is “cancel,” the method returns to step 512 and the client program continues playing the tester video. If the input received from the client program interface is “save,” then in step 520 the review tool 220 saves the contents of the text box, the timestamp, a test identifier (e.g., test A), and a tester identifier (e.g., tester A) to local storage 210. Review tool 220 also causes the client program to display a point of interest flag in the user interface to indicate where in the video the point of interest was created. In step 522, review tool 220 determines whether the playback of the tester video has been completed. If not, the method returns to step 512 and the client program continues playing the tester video. If the tester video has been played in its entirety, then in step 524 review tool 220 selects the next tester video for the test to be displayed to the agent. The method then continues with step 512.

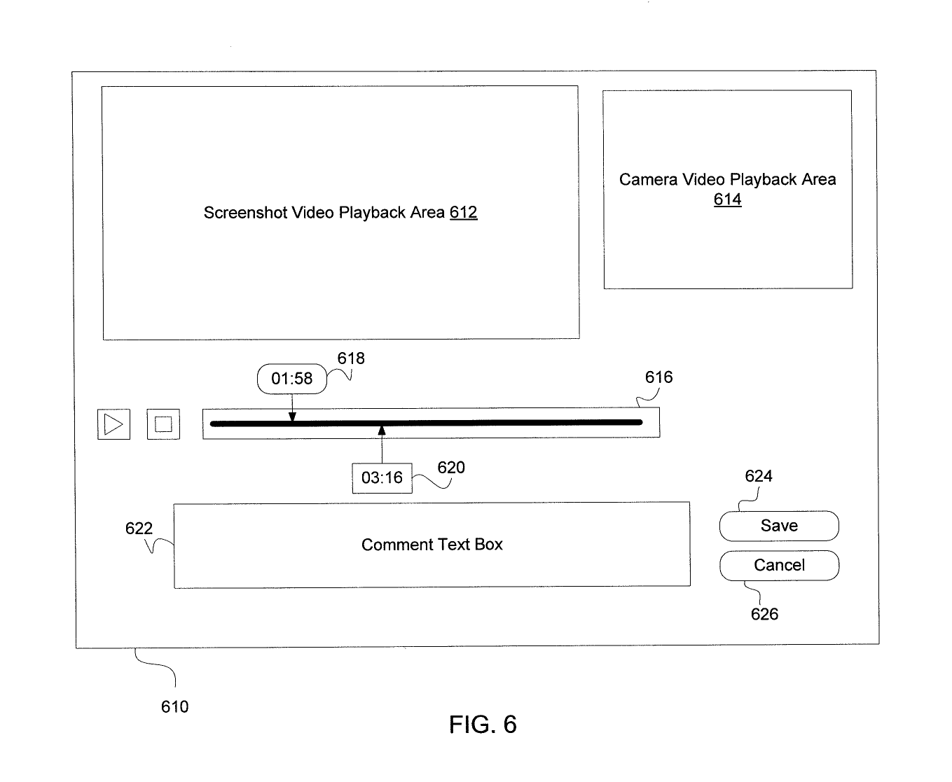

FIG. 6 is a diagram of one embodiment of a user interface 610 for creating points of interest of a test, according to the invention. User interface 610 includes, but is not limited to, a screenshot video playback area 612, a camera video playback area 614, a playback progress bar 616, a comment text box 622, a save button 624 and a cancel button 626. User interface 610 shows a point of interest flag 618 that indicates a point of interest was created at one minute and fifty-eight seconds in the tester video currently being displayed in playback areas 612 and 614. User interface 610 also shows a current point of interest flag 620 that indicates the playback has been paused at three minutes and sixteen seconds in the tester video for creation of a point of interest. Comment text box 622 enables the agent to insert text to comment on the contents of the tester video. If the agent selects save button 624, any text in comment text box 622 is sent by the client program to review tool 220 for storage in local storage 210. The client program also sends the timestamp of the point of interest and the test identifier and tester identifier associated with the tester video being played to review tool 220 for storage in local storage 210. If the agent selects cancel button 626, any text in comment text box 622 is not saved, point of interest flag 620 is discarded, and comment text box 622, save button 624, and cancel button 626 are removed from the display of user interface 610.

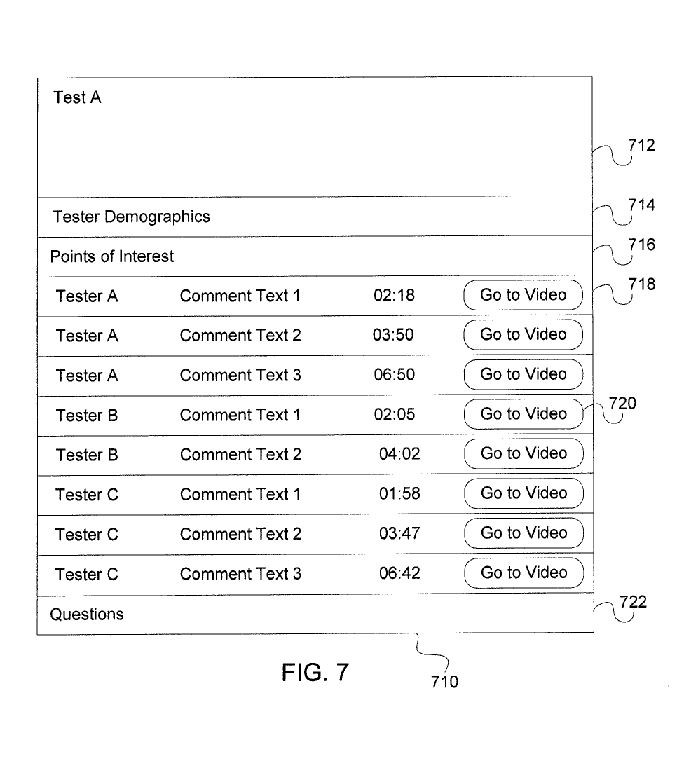

FIG. 7 is a diagram of one embodiment of a user interface 710 for viewing points of interest of a test, according to the invention. In response to a request from test playback device 150, test administrator 110 sends a client program to test playback device 150 to enable a web browser to display user interface 710. User interface 710 includes, but is not limited to, a header area 712, a tester demographics area 714, a points of interest area 716, and a questions area 722. A user can select any of tester demographics area 714, points of interest area 716, and questions area 722 to expand the area to display additional information. As shown in FIG. 7, points of interest area 716 has been expanded to show all of the points of interest for test A 718, which include three points of interest for the test results of tester A, two points of interest for the test results of tester B, and three points of interest for the test results of tester C. User interface 710 allows a user to see all of the points of interest for a particular test without having to review each of the test results for all testers. When tester demographics area 714 is expanded, user interface 710 includes information regarding the testers who completed test A such as age, gender, location, and occupation. When questions area 722 is expanded, user interface 710 includes any written questions posed to the testers after completion of test A and the testers' written responses.

As shown in FIG. 7, user interface 710 shows for each point of interest the tester, the text comment, the timestamp, and a go to video button 720. If a user selects go to video button 720 for the first point of interest for tester B, the client program sends a request to test administrator 110 to playback the video of tester B's test results for test A, starting at the timestamp of the point of interest. User interface 710 enables a user to play on demand the most important or interesting portions of any or all of the test results for a particular test without the need to view each tester's test results.

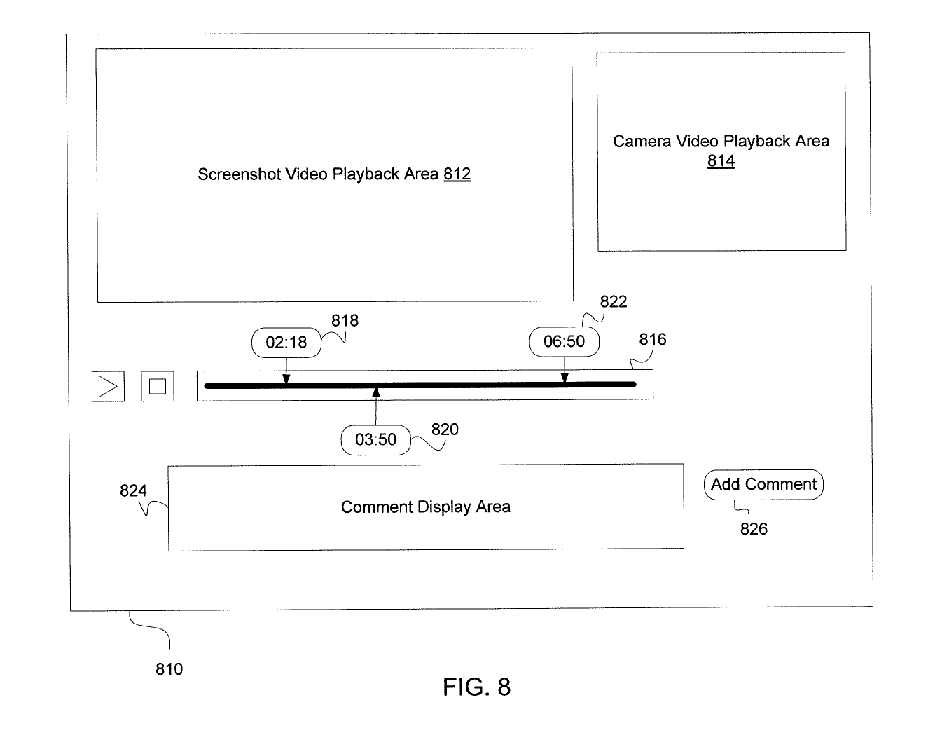

FIG. 8 is a diagram of one embodiment of a user interface 810 for viewing playback of video test results with points of interest, according to the invention. User interface 810 includes, but is not limited to, a screenshot video playback area 812, a camera video playback area 814, a playback progress bar 816, and a comment display area 824. User interface 810 also includes three point of interest flags 818, 820, and 822. During playback of video test results via user interface 810, when the progress of the playback reaches the time corresponding to the timestamp shown in point of interest flag 818, the text comment of that point of interest is shown in comment display area 824. In one embodiment, the text comment of the point of interest represented by point of interest flag 818 is displayed in comment display area 824 until the playback reaches the time corresponding to the timestamp of the next point of interest flag 820, at which time the text comment of the point of interest represented by point of interest flag 820 is displayed in comment display area 824. In another embodiment, a text comment of a point of interest is displayed in comment display area 824 for a predetermined amount of time.

Any of the text comments of the points of interest can be edited or deleted by a viewer. Each of point of interest flags 818, 820, and 822 can be selected by a viewer, and selection of one of points of interest flags 818, 820, or 822 causes user interface 810 to display a comment text box (not shown) in place of comment display area 824. The comment text box displays the current text comment for the selected point of interest and the viewer is able to modify or delete the text comment. Selection of an add comment button 826 causes the user interface 810 to display a comment text box (not shown) in place of comment display area 824 and the viewer is able to insert text to comment on the test results to create a new point of interest. Any modifications to existing points of interest or new points of interest are saved by review tool 220 in local storage 210.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
obtaining a plurality of video test results, each of the plurality of video test results corresponding to a tester;
for each of the plurality of video test results,
displaying the video test results,
receiving at least one indicator of a point of interest in the video test results,
receiving a text comment associated with the point of interest, and
saving a timestamp that indicates a position in the video test results of the point of interest and a text comment in a memory; and
creating a graphical user interface that displays the timestamp and text comment of each point of interest in each of the plurality of test video results, the graphical user interface enabling selection of a point of interest, wherein selection of a point of interest causes the corresponding video test result to be displayed beginning at the timestamp of the selected point of interest.

2. The method of claim 1, wherein the graphical user interface is further configured to display demographic information for each of the testers.

3. The method of claim 1, further comprising:
creating a second graphical user interface configured to play back video test results for one of the testers, wherein when the timestamp for a point of interest in the video test results is reached during the playback the text comment associated with the point of interest is displayed.

4. The method of claim 3, wherein the second graphical user interface includes a playback progress bar and a flag for each point of interest in the video test results being played back.

5. The method of claim 3, wherein the second graphical user interface is configured to enable a flag for a point of interest to be selected, wherein selection of a flag for a point of interest enables the selected point of interest to be edited or deleted.

6. The method of claim 3, wherein the second graphical user interface includes a button that when selected enables at least one additional point of interest to be created.

7. The method of claim 1, wherein each of video test results includes a video of the tester and a screenshot video.

8. A method comprising:
obtaining a plurality of video test results, each of the plurality of video test results corresponding to a tester;
creating a graphical user interface configured to enable creation of points of interest in the plurality of video test results;
for each of the plurality of video test results,
displaying the video test results in the graphical user interface,
receiving at least one indicator of a point of interest in the video test results,
receiving a text comment associated with the point of interest, and
saving a timestamp that indicates a position in the video test results of the point of interest and a text comment in a memory; and
creating a second graphical user interface that displays the timestamp and text comment of each point of interest in each of the plurality of test video results, the graphical user interface enabling selection of a point of interest, wherein selection of a point of interest causes the corresponding video test result to be displayed beginning at the timestamp of the selected point of interest.

9. The method of claim 8, wherein the second graphical user interface is further configured to display demographic information for each of the testers.

10. The method of claim 8, further comprising:
creating a third graphical user interface configured to play back video test results for one of the testers, wherein when the timestamp for a point of interest in the video test results is reached during the playback the text comment associated with the point of interest is displayed.

11. The method of claim 10, wherein the third graphical user interface includes a playback progress bar and a flag for each point of interest in the video test results being played back.

12. The method of claim 10, wherein the third graphical user interface is configured to enable a flag for a point of interest to be selected, wherein selection of a flag for a point of interest enables the selected point of interest to be edited or deleted.

13. The method of claim 10, wherein the third graphical user interface includes a button that when selected enables at least one additional point of interest to be created.

14. The method of claim 8, wherein each of video test results includes a video of the tester and a screenshot video.
